(19) United States
(12) Patent Application Publication
(10) Pub. No.: US 2017/0067003 A1
(43) Pub. Date: Mar. 9, 2017

(54) WATER-SOLUBLE ARTICLES COMPRISING A FILM WITH AN AVERSIVE AGENT

(71) Applicant: The Procter & Gamble Company, Cincinnati, OH (US)

(72) Inventors: Philip Frank SOUTER, Northumberland (GB); Regine LABEQUE, Neder-over-Heembeek (BE); Miguel BRANDT-SANZ, Tervuren (BE); David Xavante CUMMING, Brussels (BE); Florence Catherine COURCHAY, Brussels (BE)

(21) Appl. No.: 15/252,271

(22) Filed: Aug. 31, 2016

(30) Foreign Application Priority Data
Sep. 4, 2015 (EP) 15183842.2

(51) Int. Cl. C11D 17/04; C11D 1/83; C11D 1/22; C11D 3/37; C11D 3/30; C11D 11/00; C11D 3/32

(52) U.S. Cl. CPC C11D 17/043; C11D 11/0017; C11D 11/0023; C11D 17/045; C11D 1/83; C11D 3/32; C11D 3/3753; C11D 3/30; C11D 1/22

(57) ABSTRACT

Water-soluble articles that include a water-soluble or water-dispersible film, where the film includes an aversive agent. Processes of making such articles.

### FIELD OF THE INVENTION

The present disclosure relates to water-soluble articles that include a water-soluble or water-dispersible film, where the film includes an aversive agent. The present disclosure further relates to processes of making such articles.

### BACKGROUND OF THE INVENTION

Unitized dose articles that include compositions such as household care compositions have become increasingly popular with consumers due to the convenience they offer, for example, with regard to simplified dosing. Such articles, such as pouches, often include liquid compositions encapsulated in a compartment formed from water-soluble or water-dispersible film.

In order to deter accidental ingestion of such unitized dose articles, the film may include an aversive agent, such as a bittering agent, e.g. BITREX® (denatonium benzoate). However, it has been found that the aversive agent in the portions of film that are in contact with the liquid composition may migrate from the film into the liquid composition. As a result of this migration, the concentration of the aversive agent in the film may decrease, thereby reducing the aversive effects of the film.

There is a need, therefore, for improved unitized dose articles that include aversive agents.

### SUMMARY OF THE INVENTION

The present disclosure relates to water-soluble articles that include water-soluble or water-dispersible film, where the film includes an aversive agent. More specifically, the present disclosure relates to water-soluble articles that include water-soluble or water-dispersible film, where the film includes an aversive agent, where the film of the article forms at least one compartment and a skirt adjacent to the compartment, where the at least one compartment contains a liquid composition, and where the film of the compartment and the film of the skirt are present in a mass ratio of from about 20:1 to about 1:1.

The present disclosure further relates to processes of forming such articles.

### BRIEF DESCRIPTION OF THE DRAWINGS

The drawings are intended to be illustrative in nature only and are not intended to be limiting.

FIG. 1 shows a top view of a water-soluble article 10.

FIG. 2 shows a cross-section view of the water-soluble article 10 of FIG. 1, as viewed from line A-A in FIG. 1.

FIG. 3 shows a cross-section view of a multicompartment article 11.

FIG. 4 shows a cross-section view of a multicompartment article 11.

FIG. 5 shows a cross-section view of a multicompartment article 11.

FIG. 6 shows a cross-section view of a monocompartment article 10 formed from a single piece of water-soluble film 12.

### DETAILED DESCRIPTION OF THE INVENTION

The present disclosure relates to water-soluble articles that include water-soluble or water-dispersible film. The water soluble film includes an aversive agent and is formed into at least one compartment and a skirt adjacent to the compartment. The skirt is typically formed by joining two layers of film. The compartment may contain a liquid composition in contact with the film of the compartment.

Without wishing to be bound by theory, upon storage, the aversive agent migrates from the film of the compartment into the liquid composition until an equilibrium is reached. This results in decreased levels of aversive agent in the film of the compartment, which can lead to a reduction in deterrence efficacy and a relative waste of aversive agent material.

However, the level of aversive agent in the skirt remains relatively constant. Because the film of the skirt is not in contact with the encapsulated liquid composition, migration of the aversive agent out of the film is unlikely to occur. Thus, to counteract the migration problem and maintain the desired aversive effect of the film, the present disclosure is directed to water-soluble articles having skirts of a certain minimum size. For example, the skirt should be large enough, relative to the compartment film, to provide levels of the aversive agent that are sufficient to deter ingestion. Such articles, and processes of making such articles, are described in more detail below.

### DEFINITIONS

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, the articles including “the,” “a” and “an” when used in a claim or in the specification, are understood to mean one or more of what is claimed or described.

As used herein, the terms “include,” “includes” and “including” are meant to be non-limiting. The phases “comprising” or “comprises” are intended to include the more limiting phrases “consisting essentially of” and “consisting of.” Therefore, a composition that comprises a component may consist essentially of that component, or consist of that component.

As used herein, the terms “substantially free of” or “substantially free from” mean that the indicated material is at the very minimum not deliberately added to the composition to form part of it, or is present at levels less than about 1%, or less than about 0.1%, or less than about 0.01%, or is not present at analytically detectable levels. It is meant to include compositions whereby the indicated material is present only as an impurity in one of the other materials deliberately included.

In this description, all concentrations and ratios are on a weight basis of the composition unless otherwise specified.

As used herein, an “aversive agent” is an additive material intended to deter or minimize ingestion of an article or composition. As used herein, active materials that contribute to the intended benefit of the articles or compositions under intended conditions of use, e.g., surfactant in a cleaning article or composition, are not considered aversive agents. The aversive agents are typically present in an effective amount, e.g., an amount sufficient to provide a deterrent effect to at least a portion of a population. Aversive agents are intended to be unpleasant, but not harmful. Due to genetics, personal preferences, or other factors, some members of a population may not find a particular substance to be unpleasant. However, as used herein, the aversive agents of the present disclosure are typically found to be unpleasant by at least 50% of a population.

### Water-Soluble Article

The present disclosure relates to water-soluble unit dose articles. A unit dose article is intended to provide a single, easy-to-use dose of a composition contained within the article for a particular application. The water-soluble articles of the present disclosure may include water-soluble or water-dispersible film, described in more detail below. The film of the article may form at least one compartment and a skirt adjacent to the compartment.

The film of the article may form at least one compartment. The compartment should be understood as meaning a closed internal space within the article, which may hold a composition. At least one compartment of the article may contain a liquid composition. The unit dose article may be manufactured such that the water-soluble film completely surrounds the composition and in doing so defines the compartment in which the composition resides.

The unit dose article may comprise more than one compartment, even at least two compartments, or even at least three compartments. The compartments may be arranged in superposed orientation, i.e., one positioned on top of the other, where they may share a common wall. At least one compartment may be superposed on another compartment. The compartments may be positioned in a side-by-side orientation, i.e., one orientated next to the other. The compartments may be orientated in a “tire and rim” arrangement, i.e., a first compartment is positioned next to a second compartment, but the first compartment at least partially surrounds the second compartment, but does not completely enclose the second compartment. One compartment may be completely enclosed within another compartment.

When the unit dose article comprises at least two compartments, one of the compartments may be smaller than the other compartment. When the unit dose article comprises at least three compartments, two of the compartments may be smaller than the third compartment, and preferably the smaller compartments are superposed on the larger compartment. The smaller superposed compartments preferably are orientated side-by-side.

When the unit dose article comprises at least two compartments, each compartment may comprise identical compositions, or each compartment may independently comprise a different composition. The compartments may be sensorially different; for example, the compartments may have different shapes, or they may be different colors.

The film of the article may further form a skirt. The skirt may be adjacent to the compartment and may be located at a periphery of the compartment. The skirt may comprise excess sealed film material that protrudes beyond the edge of the compartment of the unit dose article and provides increased surface area for seal of the first and second films. The skirt may include at least two layers, or at least three layers, of film. The layers of film may be joined together.

The film of the compartment and the film of the skirt may be present in a mass ratio. Measuring the relationship of the compartment film to the skirt film as a mass ratio may be preferable to, for example, a surface area ratio because the film, particularly the film of the compartment, may be distorted or stretched during the article-making process. Maintaining the desired mass ratio may be important to ensure that a sufficient amount of the skirt and aversive agent contained therein is present in the final article. If the amount of skirt film is too low, insufficient aversive agent may be present in the film of the article to provide a deterrent effect. On the other hand, if the amount of skirt film is too high, the article may become unwieldy or suffer from dissolution problems under conditions of intended use.

The film of the compartment and the film of the skirt may be present in a mass ratio of from about 20:1 to about 1:1, or of from about 10:1 to about 1:1, or of from about 7:1 to about 2:1, or of from about 5:1 to about 2:1, or from about 3:1 to about 2:1. The mass of each portion of film and resulting ratio may be determined according to the test method described below.

The unit dose article may comprise two films. A first film may be shaped, for example by thermoforming and/or vacuum-forming, to comprise an open compartment into which the composition is added. A second film is then laid over the first film in such an orientation as to close the opening of the compartment. The first and second films are then sealed together, for example by solvent sealing, along a seal region, thereby forming the skirt. A film may also be folded onto itself and sealed at the edges, thereby forming a compartment. The unit dose article may comprise three films. A web of closed compartments may be used to seal a second web of compartments.

### Water-Soluble or Water-Dispersible Film

The unit dose articles of the present disclosure may include a water-soluble or water-dispersible film. The film may form or partially form the compartment and skirt of the article.

The film may at least partially encapsulate a composition, such as a household care composition, e.g., a fabric care composition, a detergent composition, and/or an automatic dishwashing composition. The film may encapsulate a liquid composition, a solid or granular composition, or mixtures thereof.

The water-soluble film may have a thickness of from about 20 to about 200 microns, preferably about 35 to about 150 microns, even more preferably about 50 to about 125 microns, most preferably from about 75 to about 100 microns, or about 76 microns, or about 85 microns. Thickness may be measured prior to processing or converting of the film, for example thermoforming. Different film material and/or films of different thickness may be employed in making the compartments of the present invention. A benefit in selecting different films is that the resulting compartments may exhibit different solubility or release characteristics.

The film of the present invention is soluble or dispersible in water. Preferred films exhibit good dissolution in cold water, meaning unheated distilled water. Preferably such films exhibit good dissolution at temperatures 24° C., even more preferably at 10° C. By good dissolution it is meant that the film exhibits water-solubility of at least 50%, preferably at least 75% or even at least 95%, as measured, by the method set out here after using a glass-filter with a maximum pore size of 20 microns, described below. Water-solubility may be determined at 24° C., or preferably at 10° C.
Dissolution Method: 50 grams±0.1 gram of film material is added in a pre-weighed 400 ml beaker and 245 ml±1 ml of distilled water is added. This is stirred vigorously on a magnetic stirrer, labline model No. 1250 or equivalent and 5 cm magnetic stirrer, set at 600 rpm, for 30 minutes at 24° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion, or blown extrusion of the polymeric material, as known in the art. Preferably the film is obtained by an extrusion process or by a casting process.

Preferred polymers (including copolymers, terpolymers, or derivatives thereof) suitable for use as film material are selected from polyvinyl alcohols (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the polymers of the film material are free of carboxylate groups.

Preferably, the level of polymer in the film material, for example a PVA polymer, is at least 60%. The polymer can have any weight average molecular weight, preferably from about 1000 to 1,000,000, more preferably from about 10,000 to 300,000, yet more preferably from about 20,000 to 150,000.

Mixtures of polymers can also be used as the film material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000 to about 40,000, preferably about 20,000, and of PVA or copolymer thereof, with a weight average molecular weight of about 100,000 to about 300,000, preferably about 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers, preferably polyvinyl alcohol, which are from about 60% to about 99% hydrolysed, preferably from about 80% to about 99% hydrolysed, even more preferably from about 80% to about 90% hydrolysed, to improve the dissolution characteristics of the material. Preferred films are those supplied by Monosol (Merrillville, Ind., USA) under the trade references M8630, M8900, M8779, M8310, M9467, and PVA films of corresponding solubility and deformability characteristics. Other suitable films may include called Solublon® PT, Solublon® GA, Solublon® KC or Solublon® KL from the Aicello Chemical Europe GmbH, the films VF-HP by Kuraray, or the films by Nippon Gohsei, such as Hi Selon. Suitable films include those supplied by Monosol for use in the following Procter and Gamble products: TIDE PODS, CASCADE ACTION PACS, CASCADE PLATINUM, CASCADE COMPLETE, ARIEL 3 IN 1 PODS, TIDE BOOST ORIGINAL DUO PACs, TIDE BOOST FEBREZE SPORT DUO PACS, TIDE BOOST VIVID WHITE BRIGHT PACS, DASH, FAIRY PLATINUM. It may be preferable to use a film that exhibits better dissolution than M8630 film, supplied by Monosol, at temperatures 24° C., even more preferably at 10° C.

Preferred water soluble films are those derived from a resin that comprises a blend of polymers, preferably wherein at least one polymer in the blend is polyvinyl alcohol. Preferably, the water soluble film resin comprises a blend of PVA polymers. For example, the PVA resin can include at least two PVA polymers, wherein as used herein the first PVA polymer has a viscosity less than the second PVA polymer. A first PVA polymer can have a viscosity of at least 8 centipoise (cP), 10 cP, 12 cP, or 13 cP and at most 40 cP, 20 cP, 15 cP, or 13 cP, for example in a range of about 8 cP to about 40 cP, or 10 cP to about 20 cP, or about 10 cP to about 15 cP, or about 12 cP to about 14 cP, or 13 cP. Furthermore, a second PVA polymer can have a viscosity of at least about 10 cP, 20 cP, or 22 cP and at most about 40 cP, 30 cP, 25 cP, or 24 cP, for example in a range of about 10 cP to about 40 cP, or 20 to about 30 cP, or about 20 to about 25 cP, or about 22 to about 24, or about 23 cP. The viscosity of a PVA polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. All viscosities specified herein in cP should be understood to refer to the viscosity of 4% aqueous polyvinyl alcohol solution at 20° C., unless specified otherwise. Similarly, when a resin is described as having (or not having) a particular viscosity, unless specified otherwise, it is intended that the specified viscosity is the average viscosity for the resin, which inherently has a corresponding molecular weight distribution.

The individual PVA polymers can have any suitable degree of hydrolysis, as long as the degree of hydrolysis of the PVA resin is within the ranges described herein. Optionally, the PVA resin can, in addition or in the alternative, include a first PVA polymer that has a Mw in a range of about 50,000 to about 300,000 Daltons, or about 60,000 to about 150,000 Daltons; and a second PVA polymer that has a Mw in a range of about 60,000 to about 300,000 Daltons, or about 80,000 to about 250,000 Daltons. Of the total PVA resin content in the film described herein, the PVA resin can comprise about 30 to about 85 wt % of the first PVA polymer, or about 45 to about 55 wt % of the first PVA polymer. For example, the PVA resin can contain about 50 w.% of each PVA polymer, wherein the viscosity of the first PVA polymer is about 13 cP and the viscosity of the second PVA polymer is about 23 cP.

The films may be water soluble copolymer films comprising a least one negatively modified monomer with the following formula:

[Y]−[G]ₙ

wherein Y represents a vinyl alcohol monomer and G represents a monomer comprising an anionic group and the index n is an integer of from 1 to 3. G can be any suitable comonomer capable of carrying of carrying the anionic group, for example G is a carboxylic acid. G may be selected from the group consisting of maleic acid, itaconic acid, coAMPS, acrylic acid, vinyl acetic acid, vinyl sulfonic acid, allyl sulfonic acid, ethylene sulfonic acid, 2 acrylamido 1 methyl propane sulfonic acid, 2 acrylamido 2 methyl propane sulfonic acid, 2 methyl acrylamido 2 methyl propane sulfonic acid, and mixtures thereof. Suitable films may include blends of such copolymers.

The anionic group of G may be preferably selected from the group consisting of OSO₃M, SO₃M, CO₂M, OCO₂M, OPO₃M₂, OPO₃HM and OPO₂M. More preferably, the anionic group of G is selected from the group consisting of OSO₃M, SO₃M, CO₂M, and OCO₂M. Most preferably the anionic group of G is selected from the group consisting of SO₃M and CO₂M. As used herein, M is a suitable counterion known to one of ordinary skill, such as hydrogen (H+), an alkali metal (e.g., Na⁺, K⁺), an alkali earth metal (½ Ca²⁺), or ammonium (NH₄⁺).

The film material herein can also comprise one or more additive ingredients. For example, the film preferably comprises a plasticizing agent. The plasticizing agent may comprise water, glycerol, ethylene glycol, diethylene glycol, propylene glycol, dipropylene glycol, sorbitol, or mixtures thereof. In some aspects, the film comprises from about 2% to about 35%, or from about 5% to about 25%, by weight of the film, a plasticizing agent selected from group comprising water, glycerol, diethylene glycol, sorbitol, and mixtures thereof. In some aspects, the film material comprises at least two, or preferably at least three, plasticizing agents. In some aspects, the film is substantially free of ethanol, meaning that the film comprises from 0% (including 0%) to about 0.1% ethanol by weight of the film. In some aspects, the plasticizing agents are the same as solvents found in an encapsulated liquid composition.

Other additives may include water and functional detergent additives, including surfactant, to be delivered to the wash water, for example, organic polymeric dispersants, etc. Additionally, the film may comprise an aversive agent, further described herein.

The water-soluble unit dose article may comprise an area of print. The water-soluble unit dose article may be printed using flexographic techniques, ink jet printing techniques or a mixture thereof. The printed are may be on the film, preferably on the outside of the film, within the film, on the inside of the film or a mixture thereof. The printed area may convey information such as usage instructions, chemical safety instructions or a mixture thereof. Alternatively, the entire surface of the pouch, or substantially the entire surface of the pouch is printed in order to make the pouch opaque. The print may convey an image that reduces the risk of confusion and hence accidental ingestion of the pouch.

### Aversive Agent

The present films, compositions, articles and/or methods include one or more aversive agents. As used herein, an aversive agent is an agent that is intended to discourage ingestion and/or consumption of the unit dose articles described herein or components thereof, such as water-soluble films. An aversive agent may act by providing an unpleasant sensation, such as an unpleasant taste, when placed in the mouth or ingested. Such unpleasant sensations may include bitterness, pungency (or heat/spiciness), an unpleasant odor, sourness, coldness, and combinations thereof. An aversive agent may also act by causing humans and/or animals to vomit, for example via emetic agents. Suitable aversive agents include bittering agents, pungent agents, emetic agents, and mixtures thereof.

The level of aversive agent used within or on the unit dose articles or components thereof may be at least at an effective level, which causes the desired aversive effect, and may depend on the characteristics of the specific aversive agents, for example bitter value. The level used may also be at or below such a level that does not cause undesired transfer of the aversive agents to a human and/or animal, such as transfer to hands, eyes, skin, or other body parts. The amount present may be based on the particular aversive agent's potency such that greater than 50% of humans experience an aversive effect when exposed to the given amount of the aversive agent. The aversive agent may be present at a concentration which elicits repulsive behavior within a maximum time of six seconds in cases of oral exposure.

The aversive agent in the film of the skirt, may be present in an effective level. The concentration of the aversive agent in the film of the skirt may be from about 50 to about 100000 ppm, by parts of the skirt film. The ratio of the concentration of the aversive agent in the film of the skirt to the concentration of the aversive agent in the film of the compartment is greater than 1, or from about 2:1 to about 100:1, or from about 4:1 to about 50:1, or from about 10:1 to about 30:1.

The aversive agent may be provided to the unit dose article or component thereof in any suitable manner. The aversive agent may be formulated into a film-forming material during manufacture of the film, or it may be provided after the film is manufactured, or even during or after the manufacture of the unit dose article. If the aversive agent is formulated into the water-soluble film as the film is being manufactured, the water-soluble film may comprise a substrate element and an aversive agent chemically coupled to the substrate element, for example as described in US2014/0371411A1. The aversive agent may be applied to a surface of the unit dose article or component thereof, for example by spraying, printing, atomizing, dusting, powdering, coating, painting, or otherwise depositing the aversive agent directly onto the water-soluble film and/or the finished unit dose article. The aversive agent may be provided in compositions encapsulated by water-soluble film, and may migrate to the film and/or to the surface of the film, which may be facilitated by the selection of certain solvents and/or plasticizers.

When a composition comprising the aversive agent is applied to the film and/or unit dose article, the composition may be non-aqueous so as to minimize dissolution of the film and/or article. Here, by non-aqueous it is meant that the composition may comprise less than about 20%, or less than about 15%, or less than about 10%, or less than about 5%, or less than about 1%, or about 0%, or 0%, by weight of the composition, of water. The composition may comprise up to about 100%, or 80%, or 60%, or 40%, or 35%, or 30% of the aversive agent. The composition may comprise from greater than 0% to about 100%, or from about 0.001% to about 80%, or from about 0.001% to about 60%, or from about 0.001% to about 40%, or from about 0.1% to about 35%, or from about 1% to about 30% by weight of the aversive agent.

The aversive agent may be provided in any suitable form. The aversive agent may be in the form of particles comprising the aversive agent, encapsulates comprising the aversive agent, a gel matrix comprising the aversive agent, or a combination thereof. In such forms, the aversive agent may be held within or on the carrier, within the encapsulate, and/or within the gel matrix until it is contacted with a relevant substrate, such as saliva, after which the aversive agent is released.

The aversive agent may be in the form of particles comprising a carrier and the aversive agent. The carrier may be selected from the group comprising carbonate, sulphate, zeolite, talc, clay, saccharides, polysaccharides, or mixtures thereof. The carrier may comprise a polysaccharide, which may be selected from maltodextrin, cellulose or a mixture thereof.

The carrier may form a matrix into which the aversive agent is absorbed. The aversive agent may be coated onto the carrier. The carrier may form a matrix into which the aversive agent is absorbed and the aversive agent is coated onto the carrier. For example, the aversive agent may be coated onto the carrier and then at least part of the aversive agent is absorbed into the carrier.

Wherein the aversive agent is in the form of a particle, the particle may be a spray-dry particle, an agglomerate, an extrudate, or a mixture thereof.

The aversive agent maybe in the form of a gel matrix comprising the aversive agent. A gel in this case means a composition of sufficiently high viscosity such that it substantially remains adhered to the water-soluble unit dose article until intended use. The gel matrix may comprise a wax, a saccharide, or a mixture thereof.

When the aversive agent is in the form of an encapsulate, the encapsulate may be a core and shell encapsulate, where the core comprises the aversive agent. The shell may comprise polyvinyl alcohol, melamine formaldehyde, polylactide, polyglycolide, gelatin, polyacrylate, shellac, zein, chitosan, wax, hydrogenated vegetable oil, polysaccharides paraffin and mixtures thereof. The shell may comprise a polylactide-polyglycolide copolymer. The shell may comprise a hydrogenated castor oil.

The aversive agent may be selected from the group comprising naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable aversive agents are described in more detail below.

a. Bittering Agents

The aversive agent may comprise a bittering agent. The bittering agent may be present in and/or on the unit dose articles described herein and/or components thereof.

Non-limiting examples of suitable bittering agents include denatonium salts and derivatives thereof. The bittering agent may be a denatonium salt selected from the group consisting of denatonium chloride, denatonium citrate, denatonium saccharide, denatonium carbonate, denatonium acetate, denatonium benzoate, and mixtures thereof. The bittering agent may be denatonium benzoate, also known as phenylmethyl-[2-[(2,6-dimethylphenyl)amino]-2-oxoethyl]-diethylammonium benzoate, CAS no. 3734-33-6. Denatonium benzoate is commercially sold as BITREX®, available from Macfarlan Smith, Edinburgh, Scotland, UK.

The bittering agent may be a natural bitter substance. The natural bitter substance may be selected from the group consisting of glycosides, isoprenoids, alkaloids, amino acids, and mixtures thereof. For example, suitable bittering agents also include Quercetin (3,3′,4′,5,7-pentahydroxyflavone); Naringin (4′,5,7-Trihydroxyflavanone-7-rhamnoglucoside); Aucubin; Amarogentin; Dihydrofoliamentin; Gentiopicroside; Gentiopicrin; S wertiamarin; Swerosid; Gentioflavosid; Centaurosid; Methiafolin; Harpagoside; Centapikrin; Sailicin; Kondurangin; Absinthin; Artabsin; Cnicin; Lactucin; Lactucopicrin; Salonitenolid; α-thujone; β-thujone; Desoxy Limonene; Limonin; Ichangin; iso-Obacunoic Acid; Obacunone; Obacunoic Acid; Nomilin; Ichangin; Nomilinoic acid; Marrubin; Pramarrubin; Carnosol; Carnosic acid; Quassin; Brucine; Quinine hydrochloride; Quinine sulfate; Quinine dihydrochloride; Columbine; Caffeine; Threonine; Methionine; Phenylalanine; Tryptophan; Arginine; Histidine; Valine; Aspartic acid; Sucrose octaacetate; and mixtures thereof. Other suitable bittering agents include quinine bisulfate and hop extract (e.g., humulone).

Other non-limiting examples of suitable bittering agents for use as described herein are described at BitterDB (http://bitterdb.agri.huji.ac.il/dbbitter.php), which is a free searchable database of bittering agents that holds over 680 bittering agents obtained from literature and the Merck Index and their associated 25 human bitter taste receptors (hT2Rs), and in the corresponding paper Ayana Wiener; Marina Shudler; Anat Levit; Masha Y. Niv. BitterDB: a database of bitter compounds. Nucleic Acids Res 2012, 40(Database issue):D413-419.

The bittering agent may exhibit a bitter value of greater than 1,000, or greater than 5,000, or greater than 10,000, or greater than 20,000, and/or less than 10,000,000, or less than 5,000,000, or less than 1,000,000, or less than 500,000, or less than 200,000, or less than 150,000, or less than 100,000. The bittering agent may exhibit a bitter value of from about 1,000 to about 10,000,000, or from about 5,000 to about 1,000,000, or from about 10,000 to about 200,000. The bitter value is measured using the standardized process set forth in the European Pharmacopoeia (5th Edition, Stuttgart 2005, Volume 1, General Monograph Groups, 2.8.15 Bitterness Value, p. 278).

The unit dose article or component thereof may comprise a sufficient amount of the bittering agent to provide a bitter taste, for example from about 0.00001% to about 1%, or from about 0.0001% to about 0.5%, or from about 0.001% to about 0.25%, or from about 0.01% to about 0.1% by weight of the unit dose article or component thereof.

The bittering agent may be present at a level of at least 10 ppb, or at least 50 ppb. The bittering agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

b. Pungent Agents

The aversive agent may comprise a pungent agent. Pungent agents provide pungency, which is the characteristic commonly referred to as spiciness, hotness, or “heat,” often found in foods such as chili peppers.

Non-limiting examples of suitable pungent agents may include: capsicinoids (including capsaicin); vanillyl ethyl ether; vanillyl propyl ether; vanillyl butyl ether; vanillin propylene; glycol acetal; ethylvanillin propylene glycol acetal; capsaicin; gingerol; 4-(1-menthoxymethyl)-2-(3′-methoxy-4′-hydroxy-phenyl)-1,3-dioxolane; pepper oil; pepper oleoresin; ginger oleoresin; nonylic acid vanillylamide; jamboo oleoresin; Zanthoxylum piperitum peel extract; sanshool; sanshoamide; black pepper extract; chavicine; piperine; spilanthol; and mixtures thereof. Other suitable pungent agents include polygodial, Tasmannia lanceolata extract, Capsicum extracts, or mixtures thereof. The pungent agent may comprise a capsaicinoid, for example capsaicin, dihydrocapsaicin, nordihydrocapsaicin, homodihydrocapsaicin, homocapsaicin, and/or nonivamide. The pungent agent may comprise capsaicin.

Commercially available suitable pungent agents include OPTAHEAT (Symise Flavors), HOTACT (Lipo Chemicals), and HEATENOL (Sensient Flavors).

The unit dose article and/or component thereof (e.g., water-soluble film) may comprise a sufficient amount of the pungent agent to deliver a pungent taste and/or pungent smell, for example a controlled level of pungency to a user (enough to deter ingestion but not so much as to make a human and/or animal physically ill or to accidentally transfer significant amounts to a user's hands). The article or component thereof may comprise greater than 0.0001%, or greater than 0.001%, or greater than 0.01%, or greater than 0.1%, and/or less than 20%, or less than 15%, or less than 10%, or less than 5%, or less than by 2%, or less than 1%, or less than 0.5%, by weight of the article or component, of the pungent agent. The article or component thereof may comprise from about 0.0001% to about 10%, or from about 0.001% to about 2%, or from about 0.01% to about 1%, or from about 0.1% to about 0.5%, by weight of the article or component, of the pungent agent. The pungent agent may be present at a level of at least 10 ppb, or at least 50 ppb. The pungent agent may be present at a level of from about 10 ppb to about 10,000 ppm, or from about 50 ppb to about 5,000 ppm, or from about 50 ppb to about 1,000 ppm, or from about 100 ppb to about 500 ppm, or from about 10 ppm to about 250 ppm as determined after storage of the article and/or film for one month 25° C. and 60% relative humidity.

The pungency of a pungent agent may be determined according to the well-known Scoville Scale and may be reported in Scoville heat units (SHU). The pungent agent may be selected from pungent agents having a pungency level of at least about 1,000,000 SHU, or at least about 5,000,000 SHU, or at least about 10,000,000 SHU, or at least about 15,000,000 SHU. For comparison, the pungency level of capsaicin is about 16,000,000 SHU. Pungency may also be measured by high performance liquid chromatography and determined in American Spice Trade Association (ASTA) pungency units. A measurement of one part capsaicin per million corresponds to about 15 Scoville units, and ASTA pungency units can be multiplied by 15 and reported as Scoville units.

Because it is desirable that the pungent agent be detectable in order to be an effective aversive agent, it is generally desirable that the pungency not be masked by other agents, such as cooling agents like menthol and the like. Therefore, the unit dose articles and/or components thereof may be free, for example comprising less than 5%, or less than 3%, or less than 1%, or less than 0.1%, or less than 0.01%, or less than 0.001%, or about 0%, or 0%, by weight of the article or component, of cooling agents, for example menthol and/or eucalyptus.

c. Emetic Agents

The aversive agent may comprise an emetic agent. There are two main types of emetic agents: 1) those that work directly on the gastrointestinal tract of humans and animals, and 2) those that work indirectly by stimulating the areas of the brain that control vomiting.

Non-limiting examples of suitable emetic agents that work directly on the gastrointestinal tracts are selected from the group consisting of: ipecac (ipecac syrup and/or ipecac powder) obtained from Cephaelis ipecacuanha, lobelia obtained from Lobelia inflata, mustard seed obtained from Brassica juncea, vomitoxin obtained from Fusarium graminearum, copper sulfate, and mixtures thereof. The aversive agent may comprise ipecac.

An example of an emetic agent that works indirectly by stimulating the areas of the brain that control vomiting is apomorphine (apomorphine hydrochloride).

### Composition

The composition contained in the at least one compartment may be any suitable composition for the desired application of the article. At least one compartment of the unit dose article may contain a liquid composition. The liquid composition may include an aversive agent, which may have migrated into the liquid from the film or which may have been dosed into the liquid composition prior to the formation of the article.

In a multicompartment unit dose article, the compositions in each compartment may be different, or they may be the same. The compositions may be in the form of a solid, a liquid, a dispersion, a gel, a paste, or a mixture thereof. In a multicompartment unit dose article, at least one compartment may include a liquid composition, and at least one compartment may include a solid composition, such as a granular or powdered composition. In a multicompartment unit dose article, each of the compartments may contain a liquid.

The composition may be a detergent or cleaning composition. The detergent or cleaning composition may be in the form of a powder, a compacted powder, a liquid, or a mixture thereof. By ‘liquid’ we herein mean any composition capable of wetting and treating a substrate and encompasses forms such as dispersions, gels, pastes and the like. A dispersion, for example, is a liquid comprising solid or particulate matter contained therein. The liquid composition may also include gases in suitably subdivided form.

The unit dose articles described herein may comprise the detergent or cleaning composition, for example by encapsulating the composition in a water-soluble or water-dispersible film. The detergent or cleaning composition may be a fabric detergent or cleaning composition, an automatic dishwashing detergent or cleaning composition or a mixture thereof.

By “fabric detergent or cleaning composition” we herein mean compositions that provide cleaning benefit to fabrics, care benefit to fabrics or a mixture thereof. The fabric detergent or cleaning composition may provide a cleaning benefit selected from stain removal, stain-repellency, anti-soil-redeposition, brightening, whitening dirt removal, malodour reduction or mixtures thereof. The fabric detergent or cleaning composition may provide a care benefit selected from softening, freshness, anti-wrinkling, anti-colour fading, dye transfer inhibition, anti-static or mixtures thereof.

By “automatic dishwashing detergent or cleaning composition” we herein mean automatic dishwashing compositions that provide cleaning benefits, care benefits or a mixture thereof. “Automatic dishwashing care benefits” refers to any automatic dishwashing composition that can provide shine, fast drying, metal, glass or plastic protection benefits.

The cleaning composition may comprise anionic surfactants, non-ionic surfactants, cationic surfactants, polyethylene glycol polymers, ethoxylated polyethyleneimines, rheology modifier, hueing dyes, perfumes, perfume microcapsules, chelants, enzymes, silicones, polyolefin waxes, latexes, oily sugar derivatives, cationic polysaccharides, polyurethanes, fatty acids, enzyme stabilizing systems; antioxidants, opacifier, pearlescent agent, deposition aid, builder, bleaching agent, bleach activator, bleach catalyst, organic shine polymers, surface modifying polymers, metal care agents, metal salts, anti-corrosion agents and mixtures thereof.

The detergent or cleaning composition may comprise from about 1% to 80% by weight of the detergent or cleaning composition of a surfactant. The surfactant may comprise anionic, nonionic, zwitterionic, ampholytic, zwitterionic, semi-polar, cationic surfactants or mixtures thereof. The surfactant may comprise anionic, nonionic, cationic surfactants and mixtures thereof.

The detergent or cleaning composition may comprise an enzyme. The enzyme may be selected from hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof.

The detergent or cleaning composition may comprise a polymer. The polymer may be selected from carboxylate polymers, polyethylene glycol polymers, terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, ethoxylated polyethyleneimines and any combination thereof.

Other polymers include hydroxyethyl cellulose polymer. Preferably, the hydroxyethyl cellulose polymer is derivatised with trimethyl ammonium substituted epoxide. The cellulose polymer may have a molecular weight of between 100,000 and 800,000 daltons. The hydroxyethyl cellulose polymer may be added to the composition as a particle. It may be present in the composition of the particle or may be also be present as a liquid, or a mixture thereof.

The detergent or cleaning composition may comprise a rheology modifier. The rheology modifier can be selected from the group consisting of non-polymeric crystalline hydroxy-functional materials, polymeric rheology modifiers or mixtures thereof. Specific examples of suitable crystalline, hydroxyl-containing rheology modifiers include castor oil and its derivatives. Also practical are hydrogenated castor oil derivatives such as hydrogenated castor oil and hydrogenated castor wax.

The detergent or cleaning composition may comprise a builder. Suitable builders include polycarboxylate builders include cyclic compounds, particularly alicyclic compounds. Particularly suitable are citrate builders, e.g., citric acid and soluble salts thereof, particularly sodium salts thereof. The builder may be selected from aminocarboxylate builders, preferably selected from salts of MGDA (methyl-glycine-diacetic acid), GLDA (glutamic-N,N-diacetic acid), EDDS (ethylene diamine disuccinates), iminodisuccinic acid (IDS), and carboxymethyl inulin.

The detergent or cleaning composition may comprise a bleaching agent. Bleaching agents may comprise chlorine bleaches, oxygen bleaches, or mixtures thereof. The bleach may be selected from sodium perborate monohydrate, sodium perborate tetrahydrates, sodium percarbonate, and mixtures thereof.

The detergent or cleaning composition may comprise a peroxyacid bleach precursors, preferably selected from precursors of perbenzoic acid, cationic peroxyacid precursors, peracetic acid, sodium acetoxybenzene sulfonate, pentaacetylglucose, sodium 3,5,5-trimethylhexanoyloxybenzene sulfonate (iso-NOBS), sodium nonanoyloxybenzene sulfonate (NOBS), amide substituted alkyl peroxyacid precursors, benzoxazin peroxyacid precursors and mixtures thereof. The bleach may comprise ε-phthalimidoperoxycaproic acid[phthaloiminoperoxyhexanoic acid (PAP).

Preferably, if the detergent or cleaning composition comprises an automatic dish washing composition, the automatic dishwashing composition is phosphate free, or substantially phosphate free.

The detergent or cleaning composition may comprise a hueing dye, a brightener or a mixture thereof.

Preferably the detergent or cleaning composition comprises a non-aqueous solvent, preferably between 5% and 30%, more preferably between 7% and 25% by weight of the detergent or cleaning composition of a non-aqueous solvent. Preferably, the non-aqueous solvent is selected from glycerol, ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof.

The detergent or cleaning composition may comprise water, preferably from 0.1% to 20%, more preferably from 0.5% to 15%, most preferably from 1% to 13.5% by weight of the detergent or cleaning composition of water.

### Method of Making

The present disclosure also relates to methods of making the articles described herein. The method may include the steps of: shaping a first film into an open compartment; adding a liquid composition to the open compartment; and sealing the open compartment with a second film at a seal region to form a water-soluble article, wherein the seal region forms a skirt adjacent to the compartment. The process may be continuous or intermittent.

The open compartment may be formed by thermoforming, vacuum-forming or a combination thereof. Unit dose articles may be sealed using any sealing method known in the art. Suitable sealing methods may include heat sealing, solvent sealing, pressure sealing, ultrasonic sealing, laser sealing, or a combination thereof. The sealing step may form the skirt of the unit dose article.

The film of the compartment and the film of the skirt may be present in a mass ratio of from about 20:1 to about 1:1, or of from about 10:1 to about 1:1, or of from about 7:1 to about 2:1, or of from about 5:1 to about 2:1, or from 3:1 to 2:1. The film of the compartment and the film of the skirt may be present, typically prior to the formation of the unit dose article, in a surface area ratio of from about 20:1 to about 1:1, or of from about 10:1 to about 1:1, or of from about 7:1 to about 2:1, or of from about 5:1 to about 2:1, or from 3:1 to 2:1.

The first film, the second film, or both may comprise an aversive agent as described above. The aversive agent may be a bittering agent, such as a denatonium salt or derivative thereof, e.g., BITREX®. The aversive agent may be an integral part of the film, or it may be applied after the film or article has been formed, e.g., by dusting or spraying.

The water-soluble article may contain at least two compartments, which may be side-by-side or superposed. The first film may be shaped into at least two open compartments before sealing. The second film may be part of a web of sealed compartments, which be used to seal the open compartment(s) of the first film.

In a multicompartment article, at least one compartment may contain the liquid composition, and at least one compartment may contain a solid composition. In a multicompartment article, at least two, or even all, of the compartments may contain liquid compositions. Suitable compositions are described above.

The article may include a first compartment formed from the first and second films, and at least a second compartment formed from the second film and a third film. Any or all of the films may comprise an aversive agent.

The unit dose articles may be dusted with a dusting agent. Dusting agents can include talc, silica, zeolite, carbonate or mixtures thereof.

Suitable processes of making the unit dose article of the present disclosure include a continuous process for making an article, comprising the steps of:

a. continuously feeding a first water-soluble film onto a horizontal portion of an continuously and rotatably moving endless surface, which comprises a plurality of moulds, or onto a non-horizontal portion thereof and continuously moving the film to said horizontal portion;
b. forming from the film on the horizontal portion of the continuously moving surface, and in the moulds on the surface, a continuously moving, horizontally positioned web of open pouches;
c. filling the continuously moving, horizontally positioned web of open pouches with a product, to obtain a horizontally positioned web of open, filled pouches;
d. preferably continuously, closing the web of open pouches, to obtain closed pouches, preferably by feeding a second water-soluble film onto the horizontally positioned web of open, filed pouches, to obtain closed pouches; and
e. optionally sealing the closed pouches to obtain a web of closed pouches.

The second water-soluble film may comprise at least one open or closed compartment.

In one embodiment, a first web of open pouches is combined with a second web of closed pouches preferably wherein the first and second webs are brought together and sealed together via a suitable means, and preferably wherein the second web is a rotating drum set-up. In such a set-up, pouches are filled at the top of the drum and preferably sealed afterwards with a layer of film, the closed pouches come down to meet the first web of pouches, preferably open pouches, formed preferably on a horizontal forming surface. It has been found especially suitable to place the rotating drum unit above the horizontal forming surface unit.

The resultant web of closed pouches may be cut to produce individual unit dose articles.

The process may include printing indicia such as symbols or text onto the water-soluble article. The printing may include applying a water-soluble ink to the water-soluble film by any suitable means, for example, by flexographic printing or by ink jet printing.

### Process for Treating a Surface

The present disclosure also relates to a process of treating a surface. The water-soluble article may be contacted with water, thereby dissolving or dispersing and releasing the composition contained therein to form a treatment liquor. The surface to be treated is contacted with the treatment liquor, and a treatment operation, such as washing or cleaning, is carried out. Suitable surfaces include fabric, such as laundry, or hard surfaces, such as dishware. The articles of the present invention may be used in combination with other compositions, such as fabric additives, fabric softeners, rinse aids, and the like. The treatment operations may occur automatically by machine, such as in an automatic dishwasher or laundry machine, or by hand.

### DETAILED DESCRIPTION OF THE FIGURES

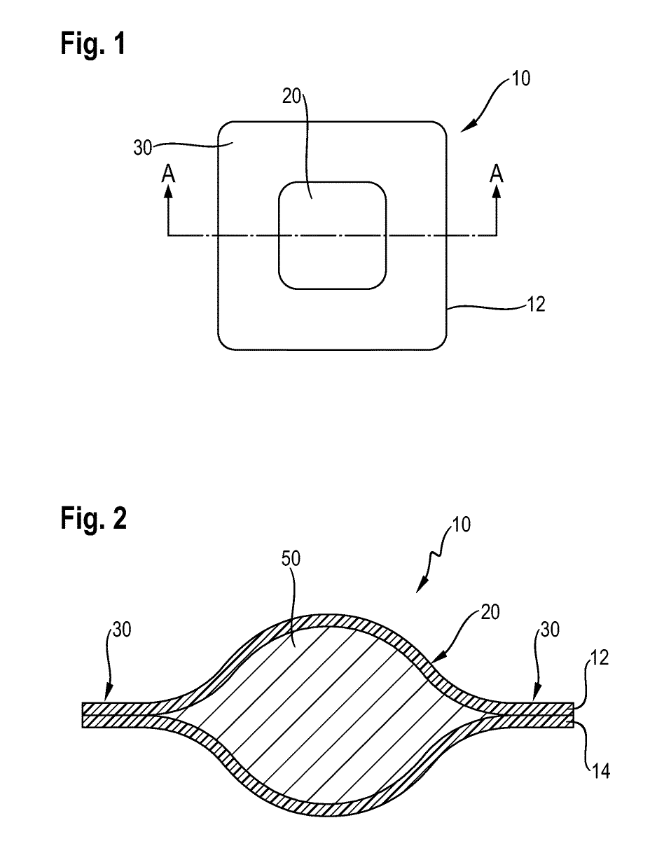

FIG. 1 shows a top view of a water-soluble article 10. The article 10 includes water-soluble film 12 that forms a single compartment 20 and a skirt 30. The compartment 20 contains a liquid composition.

FIG. 2 shows a cross-section view of the water-soluble article 10 of FIG. 1, as viewed from line A-A in FIG. 1. The water-soluble article 10 includes a first water-soluble film 12 and a second water-soluble film 14 joined at a seal region to form a compartment 20 and a skirt 30. The single compartment 20 contains a liquid composition 50. At least the skirt 30 comprises an aversive agent.

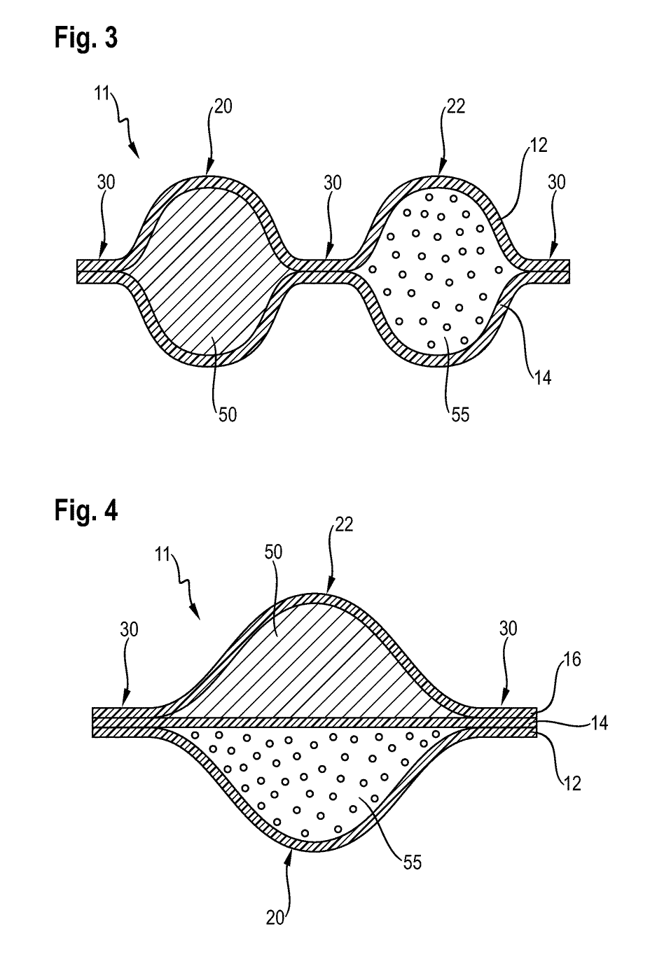

FIG. 3 shows a cross-section view of a multicompartment article 11. The article 11 includes a first film 12 and a second film 14 joined to form a first compartment 20, a second compartment 22, and a skirt 30. The first and second films 12, 14 each contain an aversive agent. The compartments 20, 22 are in a side-by-side arrangement. The first compartment 20 contains a liquid composition 50, which includes anionic surfactant. The second compartment 22 contains a solid composition 55 in granular form, which includes a bleaching composition.

FIG. 4 shows a cross-section view of a multicompartment article 11. The article 11 includes a first film 12, a second film 14, and a third film 16, joined to form a skirt 30. The first and second films 12, 14 form a first compartment 20, which contains a solid composition 55 in the form of a powder. The second and third films 14, 16 form a second compartment 22, which contains a liquid composition 50. At least the skirt 30 comprises an aversive agent.

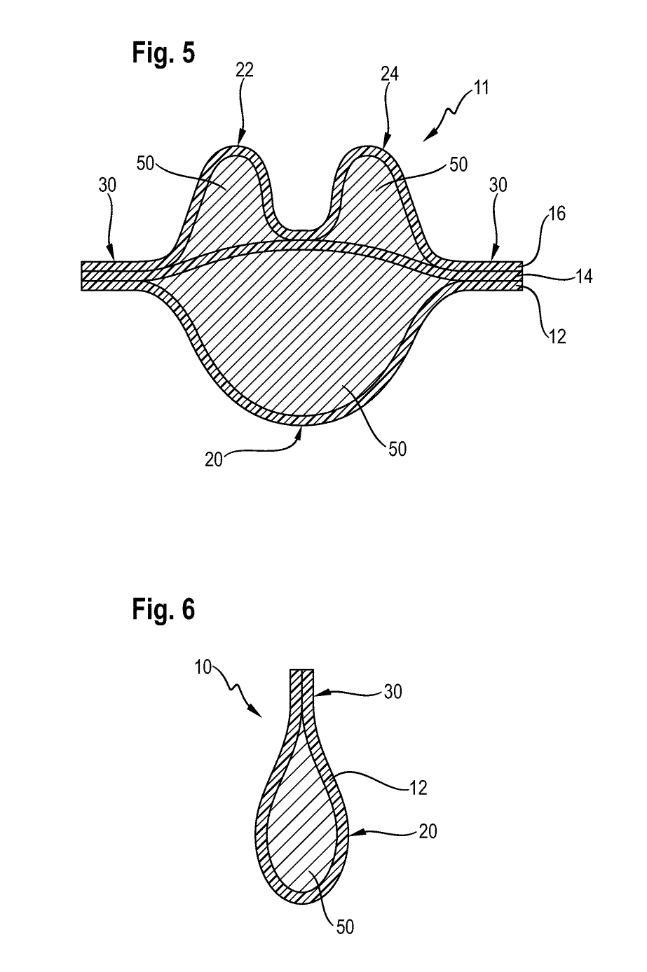

FIG. 5 shows a cross-section view of a multicompartment article 11. The article 11 includes a first film 12, a second film 14, and a third film 16. The first, second, and third films 12, 14, 16 are joined at the skirt 30, forming three layers. The first film 12 and the second film 14 are joined to form a first compartment 20. The second film 14 and the third film 16 are joined to form a second compartment 22 and a third compartment 24. The second and third compartments 22, 24 are superposed on the first compartment 20. All three compartments contain a liquid composition 50, although the components of each composition are different in each compartment. In some embodiments, the first, second, and/or third compartments 20, 22, 24 may contain a solid composition, so long as at least one compartment contains a liquid composition. At least the skirt 30 comprises an aversive agent, such as BITREX™.

FIG. 6 shows a cross-section view of a monocompartment article 10 formed from a single piece of water-soluble film 12, which is more or less folded in half and sealed. The film, including at least the skirt 30, comprises an aversive agent. The film has been folded and sealed at the sides and top, forming a skirt 30 and a single compartment 20. The compartment 20 contains a composition 50 in liquid form.

### Test Methods

### Determining Film Mass Ratio

The mass ratio of the compartment film to the skirt film may be determined prior to formation of a unit dose article, based on the mold. Prior to deformation, for example due to thermoforming, the mass/mm² of the film may be determined according to any suitable method. The area of the film that will become part of the compartment may be measured, and the area of the film that will become part of the skirt may be measured. From these measurements, the ratio may be calculated.

To determine the film mass ratio of a water-soluble article, the contents of the compartment are removed. The unit dose pouch is held with tweezers at the seal, and the surface of the each side of the film(s) is rinsed 10 times, with 4 to 5 mL of methanol used in each rinse cycle. The film that made up the skirt is removed from the film that made up the compartment(s), for example, by cutting. The films are patted dry and massed. The ratio may then be calculated.

### Method for Measuring Presence/Migration of Aversive Agent

To determine the presence and/or amount of aversive agent present on the surface of the film, sensory or analytical techniques may be employed. A suitable sensory technique (e.g., via taste in controlled circumstances) is disclosed in WO2014/026855 A1, assigned to Henkel AG & Co.

The aversive agent may be extracted from the surface via the following method. The unit dose pouch is held with tweezers at the seal. The surface of the each side of the pouch is rinsed 10 times, with 4 to 5 mL of methanol used in each rinse cycle and collected. After rinsing, the methanol solution is transferred to a glass vial, and the methanol is evaporated. The remaining extract is then dissolved in the appropriate solvent needed for the analytical method. Aversive agents can be assayed via standard methods known to those skilled in the art. Analytical techniques may include chromatography or spectroscopic techniques known to one skilled in the art. For example, suitable methods are disclosed in Falkner et al., Journal of Chromatography A. 715 (1995) 189-194, and in R. Bucci et al., Talanta 68 (2006) 781-790.

### EXAMPLES

### Formulation Examples

All levels are in weight percent of the composition.

### Example 1

### Mono Compartment Pouches

Mono compartment pouches are filled with liquid detergents of composition A, shown in Table 1. The pouches are made using polyvinyl alcohol film that contains an aversive agent and formed using standard thermoforming techniques. Specifically, 0.7 g of a 76 μm thick film (M8779, available from MonoSol, modified with BITREX®), are thermoformed to form a single compartment pouch measuring 41 mm by 43 mm. The pouch is filled with 23.7 mL (25.4 g) of composition 1.1. The ratio of the mass of the compartment film to the mass of the skirt film is about 2.5:1.

TABLE 1

| Ingredients | 1.1 |
|---|---|
| Linear C₉-C₁₅ Alkylbenzene sulfonic acid | 20 |
| C₁₂₋₁₄ alkyl 9-ethoxylate | 15 |
| Citric Acid | 1 |
| Fatty acid | 8 |
| C12-14 alkyl ethoxy 3 sulfate | 9 |
| Chelant | 1 |
| Polymer | 7 |
| Enzymes | 1 |
| Structurant (e.g., hydrogenated castor oil) | 0.15 |
| Glycerol | 6 |
| 1,2 propanediol | 11 |
| Water | 10 |
| Mono-ethanolamine or NaOH (or mixture thereof) | neutralize to pH to |
| | about 7.4 |
| Additives, Minor | To 100% |

### Example 2

### Multi Compartment Pouches

Examples of multicompartment pouches can include the formulations presented in Table 2. The pouches are made with water-soluble film according to those disclosed in US Patent Application 2011/0188784A1, modified with an aversive agent. The mass ratio of compartment film to the skirt film is about 2.4. (For at least one pouch, the film used to make the pouch has a total area of about 2368 mm², where of that film, about 691 mm² is used to make the skirt.) Table 2.

| | 2.1 | | | 2.2 | | 2.3 | | |
|---|---|---|---|---|---|---|---|---|
| | 3 | | | 2 | | 3 | | |
| | compartments | | | compartments | | compartments | | |
| | Compartment # | | | | | | | |
| | 1 | 2 | 3 | 1 | 2 | 1 | 2 | 3 |
| | Dosage (g) | | | | | | | |
| | 34.0 | 3.5 | 3.5 | 30.0 | 5.0 | 25.0 | 1.5 | 4.0 |
| Ingredients | Weight % | | | | | | | |
| Alkylbenzene sulfonic acid | 20.0 | 20.0 | 20.0 | 10.0 | 20.0 | 20.0 | | |
| Alkyl sulfate | | | | 2.0 | | | | |
| C12-14 alkyl 7-ethoxylate | 17.0 | 17.0 | 17.0 | | 17.0 | 17.0 | | |
| Cationic surfactant | | | | 1.0 | | | | |
| Zeolite A | | | | 10.0 | | | | |
| C12-18 Fatty acid | 13.0 | 13.0 | 13.0 | | 18.0 | 18.0 | | |
| Sodium acetate | | | | 4.0 | | | | |
| Enzymes | 0-3 | 0-3 | 0-3 | 0-3 | | 0-3 | | |
| Sodium Percarbonate | | | | 11.0 | | | | |
| TAED | | | | 4.0 | | | | |
| Organic catalyst¹ | | | | 1.0 | | | | |
| PAP granule² | | | | | | | | 50 |
| Polycarboxylate | | | | 1.0 | | | | |
| Ethoxysulfated | 2.2 | 2.2 | 2.2 | | | | | |
| Hexamethylene Diamine | | | | | | | | |
| Dimethyl Quat | | | | | | | | |
| Hydroxyethane | 0.6 | 0.6 | 0.6 | 0.5 | | | | |
| diphosphonic acid | | | | | | | | |
| Ethylene diamine | | | | | | 0.4 | | |
| tetra(methylene phosphonic) | | | | | | | | |
| acid | | | | | | | | |
| Brightener | 0.2 | 0.2 | 0.2 | 0.3 | | 0.3 | | |
| Alkoxylated polyamine⁶ | 5 | | | | 4 | 7 | | |
| Hueing dye⁴ | | | 0.05 | | 0.035 | | 0.12 | |
| Perfume | 1.7 | 1.7 | | 0.6 | | 1.5 | | |
| Water | 10.0 | 10.0 | 10.0 | | 4.0 | | | |
| Glycerol | 5 | | | | | 6 | 10 | |
| Sorbitol | | | | | 1 | | | |
| Propane diol | 5 | 5 | 5 | | 30 | 11 | 89 | |

| | |
|---|---|
| Buffers (sodium | To pH 8.0 for liquids |
| carbonate, | To RA >5.0 for powders |
| monoethanolamine)⁵ | |
| Minors (antioxidant, | To 100% |
| aesthetics, . . . ), sodium | |
| sulfate for powders | |

¹Sulfuric acid mono-[2-(3,4-dihydro-isoquinolin-2-yl)-1-(2-ethyl-hexyloxymethyl)-ethyl]ester as described in U.S. Pat. No. 7,169,744
²PAP = Phthaloyl-Amino-Peroxycaproic acid, as a 70% active wet cake
³Polyethylenimine (MW = 600) with 20 ethoxylate groups per —NH.
⁴Ethoxylated thiophene, EO (R₁ + R₂) = 5
⁵RA = Reserve Alkalinity (g NaOH/dose)
⁶PEI600 EO20, available from BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble article comprising water-soluble or water-dispersible film,
wherein the film comprises an aversive agent,
wherein the film of the article forms at least one compartment and a skirt adjacent to the compartment,
wherein the at least one compartment contains a liquid composition,
and wherein the film of the compartment and the film of the skirt are present in a mass ratio of from about 20:1 to about 1:1.

2. A water-soluble article according to claim 1, wherein the aversive agent is selected from a bittering agent, a pungent agent, an emetic agent, and combinations thereof.

3. A water-soluble article according to claim 2, wherein the aversive agent is a bittering agent selected from denatonium salt or derivative thereof, preferably denatonium benzoate.

4. A water-soluble article according to claim 2, wherein the aversive agent is a pungent agent comprising a capsicinoid, preferably capsaicin.

5. A water-soluble article according to claim 1, wherein the aversive agent is selected from the group consisting of naringin; sucrose octaacetate; denatonium benzoate; capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-rnethoxy-4′-hydroxy-phenyl)-1,3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

6. A water-soluble article according to claim 1, wherein the concentration of the aversive agent in the film of the skirt is from about 50 to about 100000 ppm, by parts of the skirt film.

7. A water-soluble article according to claim 1, wherein the liquid composition comprises from about 5% to about 60%, by weight of the liquid composition, of surfactant.

8. A water-soluble article according to claim 7, wherein the surfactant comprises anionic surfactant, nonionic surfactant, or mixtures thereof.

9. A water-soluble article according to claim 1, wherein the article comprises at least two compartments.

10. A water-soluble article according to claim 11, wherein at least one compartment contains a solid composition.

11. A water-soluble article according to claim 1, wherein the film of the compartment and the film of the skirt are present in a mass ratio of from about 10:1 to about 1:1.

12. A water-soluble article according to claim 1, wherein the film of the compartment and the film of the skirt are present in a mass ratio of from about 7:1 to about 2:1.

13. A water-soluble article according to claim 1, wherein the ratio of the concentration of the aversive agent in the film of the skirt to the concentration of the aversive agent in the film of the compartment is greater than 1.

14. A water-soluble article according to claim 1, wherein the liquid composition also comprises the aversive agent.

15. A water-soluble article according to claim 1, wherein the skirt is formed from at least three layers of film.

16. A method of forming a water-soluble article, the method comprising the steps of:
shaping a first film into an open compartment;
adding a liquid composition to the open compartment;
sealing the open compartment with a second film at a seal region to form a water-soluble article, wherein the seal region forms a skirt adjacent to the compartment,
wherein the film of the compartment and the film of the skirt are present in a mass ratio of from about 20:1 to about 1:1, and
wherein the first film, the second film, or both comprise an aversive agent.

17. The method according to claim 16, wherein the aversive agent is an integral part of the film.

18. The method according to claim 16, wherein the water-soluble article comprises at least two compartments.

19. The method according to claim 18, wherein at least two compartments are side-by-side.

20. The method according to claim 16, wherein the aversive agent is a bittering agent.

21. The method according to claim 20, wherein the bittering agent is a denatonium salt or derivative thereof.

22. The method according to claim 16, wherein the film of the compartment and the film of the skirt are present in a mass ratio of from about 7:1 to about 2:1.

23. The method according to claim 16, wherein the open compartment is formed by thermoforming, vacuum-forming, or combinations thereof.
